(19) United States
(12) Patent Application Publication
(10) Pub. No.: US 2014/0360095 A1
(43) Pub. Date: Dec. 11, 2014

(54) METHOD FOR PRODUCTION OF CASING FOR CULTIVATING MUSHROOMS AND/OR PLANTS

(71) Applicant: UAB "EKO INVEST", Siauliai (LT)

(72) Inventor: Kestutis Juscius, Siauliu r. (LT)

(21) Appl. No.: 14/373,047

(22) PCT Filed: Jan. 17, 2013
(86) PCT No.: PCT/IB2013/050413

§ 371 Date: Jul. 18, 2014

(30) Foreign Application Priority Data
Jan. 20, 2012 (LT) 2012 005

(51) Int. Cl. A01G 1/04; B02C 23/08; B02C 23/02; B07B 9/00

(52) U.S. Cl. CPC A01G 1/04; B07B 9/00; B02C 23/08; B02C 23/02
USPC 47/1.1; 241/81

(57) ABSTRACT

The aim of this invention is the development of an essentially new method for production of a casing layer (casing) intended for cultivation of mushrooms/plants and the use of appropriate equipment for this purpose. The invention allows the abandonment of raw materials with desired structure and enables making of preferred structure by using locally available low-quality raw materials, which is particularly relevant for countries having no raw materials suitable for the production of mushroom casing. The essence of this method is that a raw paste of ingredients is subjected to mechanical action and in the course of this action extra fibres are gradually added to the paste, fibres which quickly enter the inside of the paste and carry out the function of binding of the material being mixed (primary conglutination). Under continued mechanical action and by adding the rest of the said fibres, agglomeration of formed crumbles occurs (secondary conglutination). Thus agglomerates are formed that are later used to build the casing characterised by desired structure and resistance to mechanical action and virtually independent of the structure of raw materials used. Furthermore, this method offers the possibility to shape the casing surface to give it the desired relief (e.g. wavy surface).

### TECHNICAL FIELD

This invention relates to cultivation of mushrooms (button mushrooms agaricus bisporus, agaricus blazei) and plants. It further relates to methods for production of casing layer intended for growing mushrooms and plants.

### BACKGROUND ART

Cultivation of mushrooms comprises the following major stages:

preparation of compost (substrate to provide nutrients to spawn of mushrooms),

planting and incubation of spawn into substrate for growing,

preparation of casing layer and placing of in on the formed incubated layer,

pinning and growth of mushrooms, and

cropping of mushrooms.

Most currently available patents deal with substrates for growing: enrichment of compost with nutrient additives to obtain the greatest possible nutritive potential for fungi. Few deal with the issues of the casing layer.

There is a U.S. Pat. No. 4,170,842 published on 16 Oct. 1979. This patent deals with the casing made of synthetic materials that absorb water from processed plant waste, mushroom compost and cottonseed hulls. Water absorptive material is mixed with activated carbon, water, and limestone.

There also is a U.S. Pat. No. 6,205,703 published on 27 Mar. 2001. This patent deals with casing material 50-80% of which are made of paper and the remaining 20-50% are comprised of peat, vegetable fibres, marl, etc. with improved water storing capability and reduced nutritive content.

An American patent No. US2007209275 published on 13 Dec. 2007 deals with casing material and its use. The patent describes use of dewatered materials derived from industrial processing of coal, metal ores, rocks and extracted minerals.

There also is a South-African patent published on 20 Mar. 1996. This patent deals with artificial mineral casing comprising upper mineral casing with gaps (apertures) through which spawn moves towards the surface of the said mineral substance. The patent also deals with method for preparation (production) of such a casing.

The closest equivalent with regard to technique is U.S. Pat. No. 5,888,803 published on 30 Mar. 1999. The patent describes the method for cultivating mushrooms by using a casing layer based on granules and/or agglomerates made up of mineral fibre structures, where stone wool fibres, glass wool fibres, slag wool fibres and the like can serve as mineral fibres. The casing material may contain a binding agent, a nutrient source, a mineral source, a wetting agent, a pH-adjusting agent, etc. The composition of the casing layer establishes conditions for achievement of desired physical parameters at different stages of mushroom cultivation, for example, spawn growing or harvesting.

However, none of the above-mentioned patents deals with methodology for production of casing, which would effectively and simultaneously address several essential aspects (problems) relating to the casing layer:

1. 1. concerns of structure of casing layer;
1. 2. ability of casing layer to retain wetness;
1. 3. placing of desired layer on substrate for growing; and
1. 4. concerns of ensuring that casing layer is not contaminated.

This entire set of problems shall be described in detail below.

### DISCLOSURE OF INVENTION

### Technical Problem

### Solution to Problem

### Technical Solution

This invention is aimed at creation of essentially new method for production of casing for cultivation of fungi (in particular, mushrooms) and plants, and use of equipment appropriate for this purpose. Application/use of this method largely solves all four abovementioned problems arising for manufacturers of the said casing as well as mushroom growers (in certain countries some manufacture the casing only).

The essence of the new method is production (preparation) of casing with desired crumbling structure by using locally available organic and mineral substances. Currently available casing production/preparation technologies focus on structure of raw material used, and this invention enables formation of desired structure from available local materials (with unsuitable or hardly suitable structure) for casing, i.e., the structure of obtained raw material becomes less important (or even unimportant), which is particularly relevant for countries that do not have raw materials suitable (for use with modern technologies) for production of casing for mushrooms at all.

The essence of this invention is method for production of casing layer, during which agglomerates (of which the said casing consists) wrapped in fibres (with embedded fibres) and characterised by crumbles of predefined size and resistance to mechanical action are formed. The said fibres (fibre material) consist of substances of organic and/or mineral origin.

Application of this new method for production of casing opens up a unique possibility to use:

both currently available materials (e.g., peat of various degrees of decomposition, ground, crushed rocks of mineral origin, substrate after growing of fungi, acidity regulating agents, different sources of calcium, etc.);

and other materials not used by now for production of casing due to the aforementioned requirements for substances for casing (when applying this invention the only requirement for ‘other materials’ is that they can be used as filler inside the crumbles);

which are mixed with each other in the production process.

The matter of the method for production of casing layer according to this invention is that the said prepared raw paste (prior to addition of fibre) is subjected to mechanical action (shaken, rotated, rolled inside a drum that is cylindrical or of other shape) and in the course of this action fibres (e.g., peat fibres) are gradually added to it. At the beginning of fibre addition the fibre enters the inside of crumbles of raw material and performs the function of binding/grouping of the material being mixed (primary conglutination). Under continued mechanical action and by adding the rest of the said fibre agglomeration (secondary conglutination) of formed crumbles occurs externally, on the surface of the crumbles, i.e., agglomeration and braiding of formed crumbles take place. Crumbles formed in the course of secondary conglutination resemble agglomerates that are shaped to desirable size and rigidity, i.e. resistance to mechanical action. These crumbles-agglomerates are used to form casing layer (casing) characterised by desired structure and desired resistance to mechanical action. In case of certain compositions of materials conglutination is also possible during the process of primary conglutination, without secondary conglutination.

Depending on mechanical action (its intensity and program) changes can be made to ingredients of materials, composition of fibre, and proportions in mix. Processing intensity and duration may also vary.

### Advantageous Effects of Invention

### Advantageous Effects

### BRIEF DESCRIPTION OF DRAWINGS

### Description of Drawings

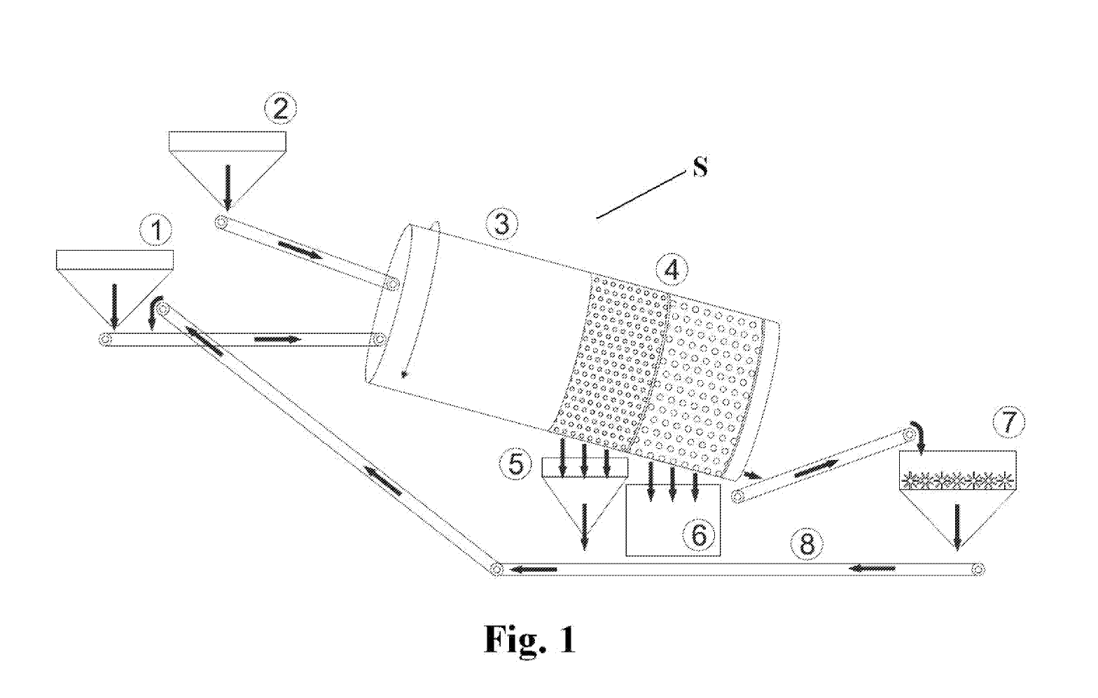

FIG. 1 shows a system reflecting the method for production of casing layer according to this invention, where structuring and separation units are based on a single rotating cylinder.

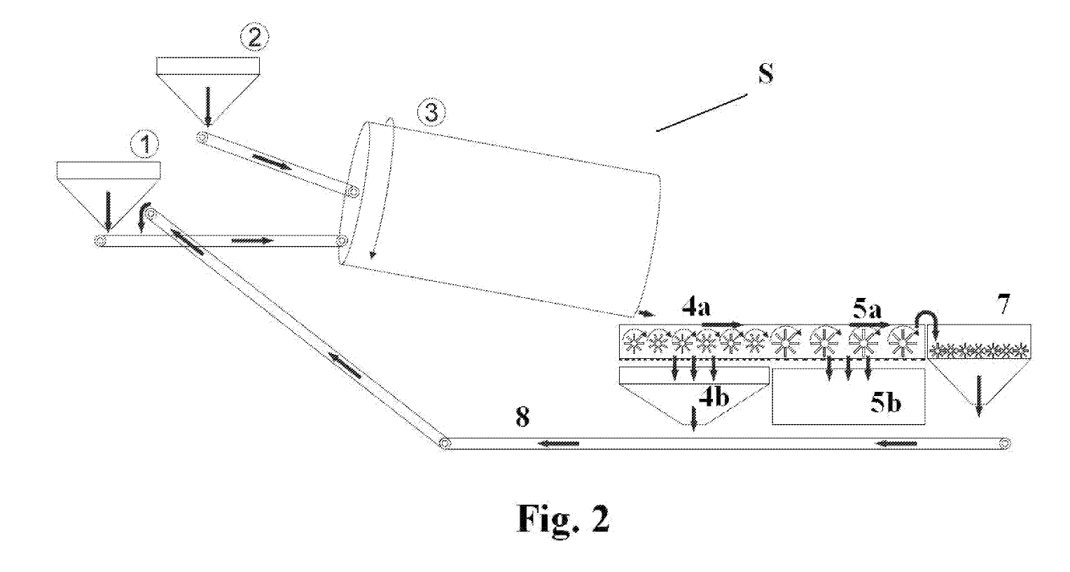

FIG. 2 shows a system reflecting the method for production of casing layer according to this invention, where structuring and separation units are separated from each other.

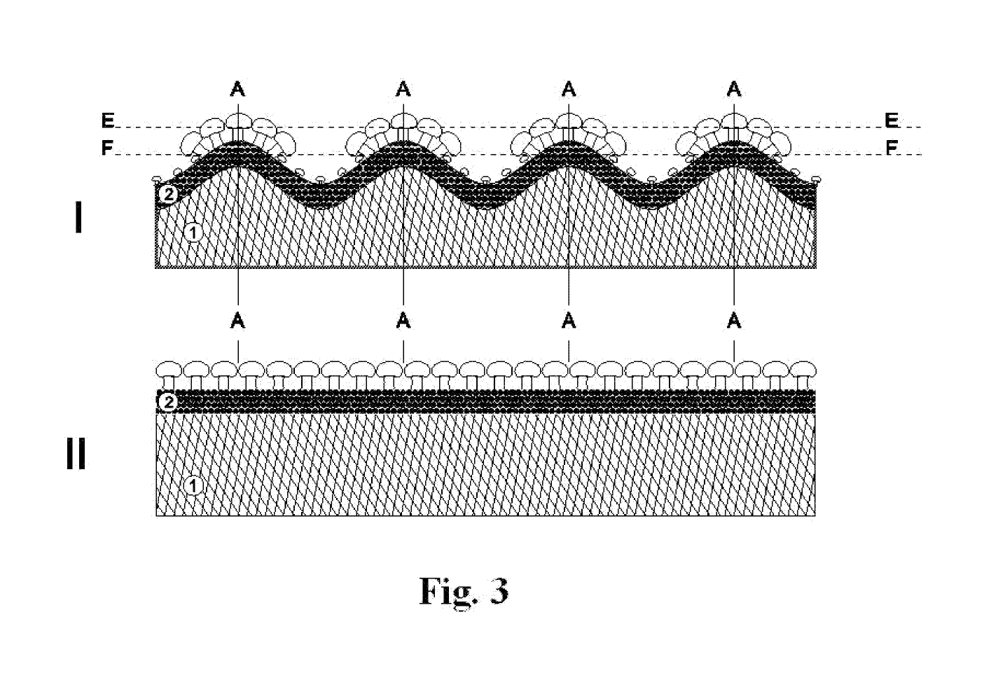

FIG. 3 shows a manner of use of casing layer according to this invention, which enables formation of uneven (patterned) layer of substrate and thus improve process of mushroom cultivation.

### BEST MODE FOR CARRYING OUT THE INVENTION

### Best Mode

Let us now examine current issues in the sector of mushroom cultivation, which are related to casing layer. Over the two recent decades production of substrate (environment for growing mushrooms) saw rather numerous qualitative technological changes leading to reduced time of production process/cycle as well as to improvement in quality and biological efficiency of substrates (ratio of the quantity of mushrooms grown to the dry substances used for their cultivation). Production process is aimed at obtaining maximum quantities of good-quality mushrooms, optimal use of substrate, achieving best possible labour efficiency, particularly during harvesting.

Casing needed in the mushroom cultivation process to serve as an environment for spawn growing, pinning and enlargement, also as a water store serves a very important function in achievement of the abovementioned goals.

If casing layer is not properly prepared it will be possible to obtain neither (quality) yield, nor quality mushrooms, nor biological efficiency, nor good labour efficiency. The key criteria that casing must meet are the following: acidity, water absorption, desired structure of casing throughout the process of cultivation, absence of fungal and competing microorganisms in casing prepared for use. Moreover, it must be technically possible and convenient (uncomplicated) to place the casing of the shelf. Economic aspect is also very important: cost for production of casing must be not high as it significantly contributes to final cost of the end product (cultivated mushrooms).

We shall go on to enumerate the major problems encountered by mushroom cultivators and/or casing producers.
1. 1. Unsuitable structure of casing layer. It may be unsuitable already at the time of casing or deteriorate in the course of cultivation, after the casing has been placed on substrate for growing. Structure of casing layer is particularly important. Casing must exhibit crumbling structure (soil) that must remain unchanged throughout the process of cultivation. Porousness of crumbles or structural elements of casing must be neither excessive, nor insufficient, so that water absorption is possible to ensure continuous presence of certain amount of free water to support the process of cultivation. The crumbles must be of special (appropriate) structure. It is best when spawn grows on the surface of crumbles only, without entering the inside of them; thus proper amount of spawn is formed, which is necessary to prevent excessive pinning on hyphae of spawn. If casing is too light, too porous, then too much spawn will take roots in peat leading to likelihood of excessive pinning, which aggravates management of quantity of mushrooms on the surface: mushrooms may press on each other and get deformed. In such casing mushrooms usually pin all at once, eliminating effect of generations, which is desired by most mushroom cultivators, especially by those picking mushrooms by hand. In case of appropriate pinning there will be generations: mushrooms pin not all at once, but gradually, making it possible to selectively pick the largest ones and leave later pinnings to keep growing. This allows for greater number of mushrooms to be picked from the cultivation place as a result of cycles of fruiting, and better quality of mushrooms can be obtained. Moreover, it increases productivity of mushroom pickers as a result of decreased need to thin mushrooms out, mushrooms tend to distribute at a distance from each other and they are easier to pick. The best results are obtained by use of heavy, little porous, fairly sticky, naturally wet, non-dried peat or other similar material for making a layer and shaping its structure by mechanical action. Size of crumbles depends on qualities and wetness of material used for layer production, and on method of processing of this material at the time of placing.

As materials used for production of casing are usually organic in origin and not homogeneous enough, it is therefore necessary (depending on materials used) to adjust wetness and mechanical processing intensity of casing during placing in order to obtain identical result, which is inconvenient to do. Natural peat excavated from peat layer is usually used for production of casing (due to homogeneous distribution of water in such peat)—thus peat retains its natural structure where structure of crumbles is preserved by less disjointed fibres of peat therein. If such peat is dried or mechanically damaged (e.g., during mechanical excavation of peat) it gets disintegrated in structure, it partially loses its qualities of retention of natural crumbling structure. There is a problem, however, that the said peat layer perfectly suitable for making such a casing can be found not in all countries where mushrooms are cultivated. For this reason natural peat based casing is transported even to other continents, for example, from the Netherlands to Australia. Transportation costs are rather substantial, because water accounts for more than half of the weight of this cargo.

Structure of casing must be preserved throughout the process of cultivation. It has been noted, however, that for certain casings, despite of placing of structurally orderly casing layer on substrate for growing the structure of the casing changes when watering is started (because in order to obtain proper yield it is necessary to additionally saturate the casing and substrate underneath with water): at first it gets very wet and later may become limp: thus proper crumbling structure turns into homogeneous agglutinated paste hardly pervious to air, gas passage from substrate is blocked, substrate decay processes begin, spawn does not take roots in some places, etc. Yield is lost in such areas, as pins are very scarce in such layer.
1. 2. Moisture retention capacity of casing layer. Casing layer must not only serve as pinning and cultivation location, but also function as a water store: it must be able to supply part of water necessary for growth of mushroom bodies (bear in mind that mushrooms derive part of water from substrate).

It has been noticed that casing is capable of absorption of large quantities of water, however, it is also very quick to release it, which makes it necessary to shorten intervals between waterings, which usually negatively affects quality of mushrooms. In light-type casing spawn takes root not only between crumbles, but also in pores, leading to reduction of space for accumulation of water/moisture. This is characteristic of more porous, lighter casings. Such casing absorbs much water, but due to porous structure it easily evaporates this water, because mushroom substrate always has higher temperature during the process of growing and therefore it acts as a kind of dryer and, with active ventilation of the room, moisture can easily evaporate through pores, i.e., such a casing gets dry rather fast. And if casing gets excessively dry, part of yield is always lost and quality of mushrooms suffers.

On the other hand: if casing is ‘heavy’, little porous and sticky, such casing absorbs less water (at a time), because such casing has less pores and therefore less water holds. However, ‘heavy’ casing retains water longer. But when this casing gets dry (when substrate is active, when harvesting cycle gets longer), it has greater tendency to become hard (compared to ‘light’ casing), leading to loss of optimum conditions for spawn and, accordingly, yield.
1. 3. Placing of desired casing on substrate for growing is technically hard to implement. Seeking to cultivate mushrooms for fresh market, better control the process of growing, and harvest more mushrooms the above-mentioned ‘heavy’ casing is more suitable. Casing of this type features sticky structure and tends to form a homogeneous paste hard to restore to desired structure, especially after long transportation. In order to give proper structure to ‘heavy’ casing it is advisable to process it mechanically at the time of placing of casing or immediately after placing it on substrate for growing. Agglutinated chunks of casing are best shredded to desirable size by various moving metal combs, hence the name of this process: combing.

It is complicated to form an even layer of casing of this type; therefore special equipment is used for this purpose. However, not all mushroom growers around the world have equipment to do this; therefore this work is done manually. It is very difficult to obtain suitable evenness and desired structure of crumbles from sticky and heavy paste of casing manually, therefore mushroom growers choose casing that is lighter and more friable (although not always optimal with regard to process of cultivation and species of mushrooms cultivated) ‘light’ casing.
4. Non-contamination of casing, i.e., absence of competing microorganisms in casing prepared for use. When cultivating mushrooms it is very important for all components used in the process of cultivation to be free from harmful microorganisms that could the adversely affect the process of cultivation. Manufacturing process of substrate as an environment for growing intended for cultivation of mushrooms involves a stage of substrate pasteurisation during which the major part of harmful microorganisms is destroyed by (relatively) high temperature (58° C.). Therefore non-contamination of substrate is ensured provided that standards of production process are followed correctly. However, casing these days usually (with rare exceptions) is prepared worldwide without thermal processing. Materials of which casing is made are mixes of mineral and organic substances that naturally are not free from possible contamination with competing microorganisms.

It must be admitted that certain substances (e.g., acid peat with pH of 3 to 4) are naturally immune to pathogenic fungi, however their way from acquisition and transportation to production of casing is not sterile, therefore at addition to mixing lines and adjustment of casing acidity to neutral (approx. 7.5 pH: optimal for cultivating mushrooms), natural protection is lost and all pathogenic (harmful to mushrooms) microorganisms that get in during mixing and transportation can develop in such casing. An even greater problem related to competing microorganisms occurs when acidity of substances for producing casing is close to neutral level, i.e., equal to approximately 7.5 pH. If so, harmful microorganisms could have been living at substance acquisition location for ten years or more and the infection at delivery of raw material to casing producing company can therefore be very high. To destroy harmful pathogens efforts are made to treat mix for casing with chemicals (e.g., formaldehyde solution), yet such solutions are unwanted as there is not guarantee that later they will fully leave the substrate for growing, and such substances are highly unwanted in human body (mushrooms will be supplied for human consumption). Some producers try to perform thermal disinfection, but this is not an easy task. Peat (it is usually a major component) is bad thermal conductor, which makes it difficult and time-consuming to evenly heat the entire paste (major condition in pasteurisation) to a certain point without overheating some areas of this material. Moreover, casing material has to be mixed continuously during pasteurisation or it will be impossible to achieve even processing, i.e. sufficient quality of pasteurisation of layer. This makes it necessary to use special mixers and consumes energy. To optimise use of equipment pasteurisation cycle is shortened and higher temperatures are used leading to destruction of not only harmful microorganisms but also microflora valuable to mushrooms.

This invention is aimed at creation of essentially new method for production of casing layer for cultivation of mushrooms (in particular, button mushrooms) and equipment appropriate for this purpose. Application of this method largely solves all four abovementioned problems arising for manufacturers of the said casing layer as well as mushroom growers (in certain countries some manufacture the casing only).

The essence of the new method is production of casing layer with desired crumbling structure by using locally available organic and mineral substances. Currently available casing production/preparation technologies focus on structure of raw material used, and this invention enables formation of desired structure from available local materials (with unsuitable or hardly suitable structure) for casing, i.e., the structure of obtained raw material becomes less important (or even unimportant), which is particularly relevant for countries that do not have raw materials suitable (for use with modern technologies) for cultivation of mushrooms.

Presently used casing production method requires raw material with naturally crumbling structure. Elements of this structure (crumbles) do not get disintegrated due to presence of fibres within them, which act as stabilisers and prevent crumbles from disintegration even under mechanical action during mixing with other materials. When there is too little of the said fibres, attempts are made to add more fibres to the paste for casing. These extra fibres serve as natural binding agents for paste for casing. Casing prepared in this way (by adding extra fibres) is placed on substrate for growing (substrate, compost) and under mechanical action by various rotating means a structure of desired size is formed at the moment of placing, right after covering. But crumbles in such casing are dependent of many factors: moisture, degree of decomposition, and coefficient of natural stickiness of raw material, structure of added fibre, uniformity of blending of fibre in casing, previously-mentioned mechanical means, etc. Because the range of these factors is so broad and characterised by great variety, it is always difficult to accurately plan for all the important factors at production, which will determine mechanical properties (quality of making of pieces of required size, resulting from addition of extra fibre) of the casing once its production is completed.

The essence of this invention is method for casing production during which crumbles (they make up the said casing) wound around with fibres (having ‘built-in’ fibres) and characterised by crumbles of predetermined size and resistance to mechanical action are formed. These fibres are made of substances of organic and/or mineral origin.

Application of this new method for production of casing layer opens up a unique possibility to use:

both currently available materials (e.g., peat of various degrees of decomposition, ground, crushed rocks of mineral origin, substrate after growing of mushrooms, acidity regulating agents, different sources of calcium, etc.);

and other materials not used by now for production of casing layer due to the aforementioned requirements for substances for casing layer (when applying this invention the only requirement for ‘other materials’ is that they can be used as filler inside the crumbles);

which are mixed with each other in the production process. The obtained paste must be moistened to required level that depends on natural stickiness and propensity for agglutination of ready materials used for the paste. The said mixing having been completed and optimum factor of acidity (usually about 7.5 pH) having been achieved throughout the mixed paste, fibres are added. The fibres may be organic, mineral, or artificial in origin—the important aspect is their capability to preserve adequate fibre structure and not to disintegrate more than desired level when mushrooms are fruiting.

The purpose of the fibre is to provide desired structure, crumble size, and resistance to mechanical action (compression). The cheapest and most widely available fibres nowadays are natural pet fibres obtained from peat by separation or some other method. Fibre must be shredded and cut down to required length, its parameters depend on mass of raw materials used.

The essence of method for production of casing layer according to this invention is that the said prepared raw paste (prior to addition of fibre) is subjected to mechanical action (shaken, rotated, rolled inside a cylindrical drum) and in the course of this action fibres (e.g., peat fibres) are gradually added to it. At the beginning of fibre addition the fibre enters the inside of crumbles of raw material and performs the function of binding/grouping of the material being mixed (primary conglutination). Under continued mechanical action and by adding the rest of the said fibre agglomeration (secondary conglutination) of formed crumbles occurs externally, on the surface of the crumbles, i.e., agglomeration and braiding of formed crumbles take place. Crumbles formed in the course of secondary conglutination resemble agglomerates that are shaped to desirable size and rigidity, i.e. resistance to mechanical action. These crumbles-agglomerates are used to form casing layer (casing) characterised by desired structure and desired resistance to mechanical action.

Depending on mechanical action intensity and program changes can be made to ingredients of materials, composition of fibre, and proportions in mix. Processing intensity and duration may also vary.

Hereafter one of the methods for action on the prepared mixed raw paste and fibres is given. It is not the only possible method but rather one of the options.

The said raw paste based, in this case, on mixture of highmoor and lowmoor peat of average decomposition, is prepared. Acidity is adjusted by adding chalk (calcium carbonate) by blending it in the said raw paste (presently available mixing machinery and tools are used to do this). 50% of required chopped peat fibre are added during mixing (it is one of the abovementioned options of the fibres). The mixed paste is guided to rotating mixer. Due to mechanical action (rotation, rolling and shaking) formation of balls (crumbles) begins in the moving mix. Next, mixing continues while the remaining portion of fibre (e.g., chopped fibre) is gradually added to the paste wherein crumble formation is beginning, and in this rotating paste containing sticky and free components that portion of fibre agglomerates and winds around the surface of crumbles.

At the beginning of mixing, when 50% of fibre are added (the proportion may vary, for example, theoretically as much as 100% of the fibre may be added at the beginning of mixing), the fibre gets mixed inside crumbles and serves the function of binding or grouping of the material being mixed (primary conglutination). The longer this process, the less lone, non-agglutinated pieces remain and the larger crumbles are formed. When the remaining part of fibre (e.g., prepared peat fibre) is added it mainly agglomerates the formed crumbles externally, on the surface of the crumbles, because primary conglutination prevents fibres from getting inside, i.e., it performs the function of agglomeration and braiding of formed crumbles. The formed crumbles now resemble agglomerates (secondary conglutination) that are shaped to desirable size and rigidity (resistance to mechanical action).

Size of crumbles depends on the following factors: intensity of mixing during primary conglutination, duration of this process, and ingredients in raw paste. This allows obtaining crumble size that is optimal for the species of fungi cultivated. Another very important property of crumble is crumble rigidity or resistance to mechanical action. The more rigid (the more covered with fibre) the formed crumbles, the greater their resistance to further mechanical action unavoidable during transportation or placing of casing on substrate.

Sizes of crumbles obtained during the said primary conglutination differ, therefore to sort the crumbles by size it is advisable to pass them through sorting/calibration device that would return too small crumbles to beginning of the process so that they continue gaining mass and shred too large crumbles (shredded product is returned to the beginning of the process).

FIG. 1 shows a system (S) embodying the method for production of casing layer according to this invention, where structuring and separation units are based on a single rotating cylinder. This system (S) is made up of the following parts:

ingredient feed unit (1);

fibre feed unit (2);

structurer (3), i.e., structure building unit major parts of which are mixing and agglutination sections;

separator (4), i.e., sorting/separation unit major part of which is rotating part of cylinder and which is permanently connected to structurer unit (3);

too small fraction crumble separation unit (5);

desirable fraction crumble separation unit (6);

too large fraction crumble shredder (7);

conveyor system (8) returning pieces of unsuitable fractions to beginning of the process.

Raw paste ingredients and fibre are prepared accordingly, that is, unnecessary materials such as stump parts, wood pieces, rocks etc. are removed. The said raw material and fibre are sent to structurer (3) major part of which is rotating cylinder. At the beginning of structurer (3) unit (this component is alternatively called mixer) ingredients of the said raw paste are smoothed (if they are not homogeneous) and mixed with each other. This mixed paste may also be additionally moistened. Mixing process having been completed this paste is gradually pushed out of structurer (3) mixing section to structurer (3) agglutination section where the said raw paste is mixed with fibre (e.g., peat fibre) and formation of the said balls/crumbles begins. The basis of structurer (3) is a cylindrical drum with paddles inside of it, therefore as cylinder rotates the formed crumbles get separated and move towards separator (4). The basis of separator (4) is a cylindrical drum with apertures (openings) of changeable size and shape through which agglomerates of appropriate size and shape fall out. Agglomerates that are too small are separated by using too small fraction crumble separation unit (5). Agglomerates of desirable fraction are separated by using desirable fraction crumble separation unit (6). Crumbles that did not get on conveyor belt (i.e., did not fall through separation apertures) continue to crumble shredder (7) and are returned to the beginning of the process by conveyor. All agglomerates that fell out get on conveyor belt that carries them to further processing, recycling or packing sections.

FIG. 2 shows a system reflecting method for production of casing in accordance with this invention, where structuring and separation units are mutually independent, i.e. they are arranged as separate devices. In this case structuring principle remains the same, but crumble separation unit is included as a separate module. Its working principle is different. Exiting the structurer (3) agglomerates of different sizes enter separation unit where rotating paddles (distance between rotating parts may vary) first separate too small fraction (4a, 4b). The too small fraction separation unit (4a, 4b) is followed by desirable fraction separation unit (5a, 5b), and finally parts that are too large are directed to shredder (7). Conveyor system (8) returns agglomerates of unsuitable fractions to beginning of the process, that is, to structurer (3). This method of separation (where structuring and separation units are separate) facilitates changing of structure of desirable fraction by adjusting distances between rotating paddles (4a, 4b and 5a, 5b), while changing crumble size in separation unit (4) of equipment shown in FIG. 1 is rather complicated.

Systems (lines) presented in FIG. 1 and FIG. 2 do not necessarily have to be such. They cover all modifications obvious to specialists in that field when applying this invented method for production to the production process. The drawings reflect only some of possible embodiments.

These possible embodiments show that casing produced by applying this new method has desirable structure the components (agglomerates) of which feature desirable size, rigidity, and resistance to external mechanical action. Another very important aspect is that mushroom growers can manage this structure to suit their needs. Application of this method for production and equipment allows obtaining agglomerates of such rigidity that their structure is preserved both after transportation (one of the major issues presently) and after mechanical placing of casing on substrate for growing (conveyors, rotating parts etc. are involved here). Moreover, there are desirable side effects, for example, during and after watering crumbles produced by this new method do not get soft, do not melt, and casing does not spill over the substrate. This retains gas flow from substrate to the room and reduces chances/probability of development of competing microorganisms. As the method according to this invention completely ensures that agglomerates obtained are of appropriate size, mushroom growers have much greater control over quantity of spawn in casing. Moreover, the growers can achieve much better effect of generations, which is highly important in mushroom cultivation sector. It opens up a unique possibility to form repeated quantity of valuable spawn highly affecting pinning on surface of casing.

If a mushroom grower wants to cultivate smaller mushrooms, he usually chooses finer structure for casing. But if he focuses on the large mushroom market, he usually chooses casing with bigger crumbles leading to sparser spawn and, consequently, sparser pinning under the same climatic (external) conditions. This is because spawn growing in casing can hardly enter the inside of agglomerate because of its dense (agglomerated) structure and therefore attempts entering the prepared casing largely around the surface of agglomerate. Thus spawn usually grows around agglomerates and on the surface of them, while the inside of agglomerates serves as a great water store to support healthy growth of mushrooms. Casing produced by this method is able to accumulate more water compared to presently used casings with standard structure. There is another important aspect: agglomerates release water gradually and moisture evaporates from casing slower. This is because crumble material may have porous structure that, under normal conditions, accumulates water in pores/capillaries (this is characteristic of highmoor peat), but due to agglomeration of crumbles the pores are ventilated less, evaporation is lower and casing retains moisture longer. If casing is produced by old (current used) method, spawn entering the casing takes roots in pores fairly strongly, which leaves less space for water. But if casing is produced by the new method, not only spawn does not penetrate inside of crumble through agglomerate, but also moisture evaporates less easily. Because spawn usually grows around agglomerates only externally, spawn is stronger in such casing, and once spawn has fully penetrated casing hyphae of spawn wind round agglomerates and biological film that increases amount of water preserved and retains that water in casing forms. Therefore production and use of casing produced according to this new method allows achieving better qualitative and quantitative characteristics related to mushroom production (cultivation). This is because even (homogeneous) structure at all points of cultivation enables much more even spread of spawn to casing. This enables selection of the same optimum climatic (external) conditions for all shelves. Presently, when spawn grows unevenly, climatic conditions need to be selected (optimized) solely on the basis of multitude of mushrooms growing, that is, climatic conditions are optimized not for all mushrooms, but, in the best case scenario, only for most of them (assessment focuses on spawn growth depth and density). When spawn grows evenly cleaner mushrooms are obtained, because casing is free from fine components mushrooms get splashed with during watering of casing. This new method improves water absorption and retention qualities of casing, therefore it is possible to prolong periods between waterings without casing getting excessively dry while mushrooms are being cultivated. It is a known fact that direct sprinkling of water on mushrooms while they are being cultivated may affect quality of produce very adversely. But use of the new casing (enabling to do watering less frequently) allows pouring water only before or after tides of cultivation, that is, between cycles of mushroom fruiting.

Casing produced by method in accordance with this invention is very easy to spread on shelves evenly, because agglomerates are easy to spread on surface of cultivation area. This casing can be spread on shelves both mechanically (structure does not collapse under mechanical action) and manually, with equal success. Placing of casing having been done the only thing to do is to make surface structure even and compress to achieve desired density of casing. Use of casing produced by this new method will be particularly beneficial for mushroom growers placing casing manually, as they will no longer have to seek compromise between optimum structure of casing and possibility to properly place such casing on substrate for growing.

Casing produced in accordance with this invention opens up new possibilities, i.e. the casing can be used to improve process of cultivation of mushrooms. FIG. 3 shows application of casing produced in accordance with this invention, which involves formation of uneven (wavy) layer of substrate to improve process of cultivation of mushrooms. The matter of this application is innovative, higher quality pinning and growth in casing surface that is not even but wavy or not flat in some other way (in contrast to contemporary methods of cultivation). Mushroom growers using contemporary cultivation technology strive to place substrate on shelves as evenly as possible, later evenly place casing on it and give this casing a desired structure (even, more or less crumbling) during placing. Crumbling structure of casing makes surface for growing wavy, but it is placed on even surface of substrate, therefore if surface structure of casing is too uneven (measuring from surface of substrate), the layer will become uneven. Spawn penetrates casing from below (from substrate layer) and from admixed spawned substrate or from special spawn intended for casing (casing inoculum). If casing layer is uneven, quality of spawn in casing is uneven as well, because good quality of spawn in casing is achieved only when it receives nutrients from major layer of substrate (from below), while additives in casing or casing inoculum only speed up more even penetration of casing provided that spawn growing from additives in casing ‘joins’ the lower, main spawn present in substrate. Therefore if casing is even, quality of spawn will also be even throughout the casing. Even quality of spawn enables good control of pinning in later stages of mushroom cultivation. If quality of spawn in all areas of casing is not even enough, pinning will be hard to control: in some areas pins will be excessive while in other areas they will be too scarce, moreover, pins will be weak. When quality of spawn is low, some pins will occur not only at surface of casing, but in deeper layers of casing as well.

Casing produced in accordance with this invention is easier to place not only on even surface of substrate, but also on uneven, patterned surface, or on surface being formed during placing. Casing produced in accordance with this invention and consisting of crumbles of desired resistance and size can be technically placed on prepared uneven substrate or even substrate that is mechanically affected/compressed through the layer, resulting in formation of patterned surface. To avoid sticking of crumbles under mechanical action it is advisable to increase crumble resistance to compression, because gaps between crumbles, which allow for gas emissions from substrate and growth of spawn in it, must remain. The so-called ‘heavy’ casing usually used these days is impossible to place on uneven substrate, because casing of this type must be tilled mechanically or it will be agglutinated. Meanwhile dry, so-called ‘light’ casing is also very difficult to place on uneven surface due to propensity to crumble off, and likeliness to get leached during watering.

Casing produced in accordance with this invention does not have the above-mentioned drawbacks or they are substantially slighter. This casing does not require mechanical tilling during placing, therefore casing inoculum can be blended in prior to placing of casing. Mechanical placing does not affect its structure. It is also noteworthy that structure of casing produced by the new method is resistant to water action: water does not wash crumbles away and does not change their structure. Such casing can be placed on even surface, too, and waves or other pattern can be given to the surface of casing by mechanical pressure after it has been placed. In such case mechanically pressed crumbles in casing impress surface of substrate and mirror the pattern of surface of casing.

Casing produced in accordance with this invention establishes conditions for new method of placing and of mushroom cultivation to appear (FIG. 3). At the top of FIG. 3 the new method to place casing (I) is shown, and at the bottom there is currently available and used method (II). Surface shaped in accordance with the new method (II) has larger area on which multiple generations of mushrooms form over time, they do not interfere each other. This increases biological efficiency of mushrooms and efficiency of use of casing. Substrate-casing contact surface is much larger, leading to better use of nutrients within substrate: not only quantity but also nutritive value of mushrooms is increased. Not 6 but 10 mushrooms can now be cultivated in the same projection area, which is ˜66% more (FIG. 3). The new method enables first obtaining mushrooms on ridges (axis E crosses them at their centres) and then in hollows (axis F). Mushrooms growing on ridge at axis E do not press against smaller mushrooms in hollows (axis F). Mushrooms enlarged on ridges having been picked, mushrooms in hollows are given space for lateral expansion to areas previously occupied by mushrooms that now have been picked. This method not only significantly increases yield and quality of mushrooms, but also enhances efficiency of process of mushroom picking. If mushrooms grow on ridges and distinctive ‘furrow’ has been formed, they are easy to pick, because mushrooms can be simply tilted towards hollows without damaging smaller mushrooms below (axis F). If all mushrooms grow at the same level, great care must be exercised when picking a matured mushroom in order not to damage adjacent smaller mushrooms (mushrooms are picked by turning them). If mushrooms grow all at once they need to be thinned out, which not only is very difficult and time-consuming to do, but also leads to reduction of quality of mushrooms as it is virtually impossible to thin mushrooms out without harming the adjacent ones. Cultivation of mushrooms on uneven surface enables sparser placing of pins, and thinning mushrooms out becomes entirely or largely unnecessary. For cultivating mushrooms on ridges and later (in certain order) in hollows (valleys) this method can be slightly modified to enable managing pinning at desired locations. Obtaining pins at the said locations can be facilitated by placing appropriate cover (film, paper, etc.) on these locations. Holes (apertures) with special layout should be made in this cover: they would allow ambient air from cultivation room to reach surface of casing. Casing surface at the said apertures would have different microclimate more appropriate for pining, while due to CO₂ emissions from substrate and levels of temperature and humidity microclimate at covered areas is more favourable for vegetative growth of spawn than pinning. Therefore under the same ambient conditions pins on surface of casing would develop at different times, that is, in the planned order. It is best to make the said cover by using paper with properly laid out holes/apertures. Wet paper is even more suitable, because it excellently covers the surface of casing and prevents ambient air in cultivation room from reaching surface of casing from outside. If pinning is not good enough, it is always possible to improve the conditions by watering, because water stream stimulates pinning of mushrooms. Covered areas do not receive direct water stream: this stimulates pinning only in predefined areas: at the said apertures.

This new method offers one more very important advantage: this casing production method allows ensuring that casing is biologically clean: free from harmful microorganisms and fungal pathogens. The casing produced by the new method has a crumbling structure that preserves its characteristics even having been poured on thickly, therefore the casing can be placed in different containers or boxes where, ventilated bottom having been installed and connected to active ventilation system, such containers are easy to blow through with air from active ventilation system and if such ventilated containers are placed in thermally insulated rooms casing can be pasteurised to desired temperature. Air gaps between crumbles ensure even temperature throughout the casing being pasteurised. This casing production method and casing pasteurisation method enable use of excess heat (released during production from substrate for growing) in mushroom compost, which can be used in pasteurisation process.

Large amounts of excess heat are emitted from compost pasteurisation rooms during substrate pasteurisation; this heat is usually simply released to external environment (atmosphere). Temperature of these streams of heat is as high as 58° C.: such temperature is ideal for pasteurisation process, therefore these streams can be guided to ventilation system of casing pasteurisation room. Depending on method for production of substrate, this heat is entirely (or at least partially) sufficient to ensure process of casing pasteurisation. Moreover, air released from compost pasteurisation room is not only hot, but also characterised by high concentrations of ammonia that, along with high temperature, efficiently destroys pathogens in casing. Casing partially absorbs ammonia and acts as a biological filter. Pasteurisation process having been completed, casing can be conditioned in the environment of useful thermophilic fungi that best multiply at temperatures of 45-50° C. Optimal temperature is ensured by air stream released from substrate during substrate conditioning process (the next process after substrate pasteurisation), therefore maintenance of temperature does not require any additional sources of energy. Using ammonium nitrogen dissolved in casing thermophilic fungi also consume remaining free sugars possibly present in components of casing mix and enrich casing with thermophilic fungi biomass that is nutriment for spawn and also stimulates faster growth of mushrooms. If the said casing mix has no free sugars and grower wants to speed up spawn rooting at points of mushroom cultivation, he can add extra ingredients (such as Melasa that not only provides thermophilic fungi with extra nutrients during casing conditioning but also improve adhesion of ingredients and fibre during formation of crumbles) containing plenty of free sugars to initial mix during casing preparation. Because of consumption of free sugars by thermophilic fungi, competing microorganisms poorly grow in such environment, i.e. casing produced in accordance with this new method has stronger immunity against fungal diseases.

Pasteurisation and/or conditioning of casing having been done casing can be transported to points of cultivation without re-loading, in the same containers where pasteurisation was performed: this best ensures that casing does not get contaminated after pasteurisation. It must also be noted that chemical disinfection of casing produced in accordance with this new method can be much more efficient, because prepared agglomerates are much easier to evenly cover with disinfectant. Chemical treatment can be applied at the final stage of formation of agglomerates. This is not easy to do with currently produced casings, because if disinfectants are sprayed on finished casing with agglomerates of very different sizes, the disinfectants penetrate casing very unevenly. Therefore chemical disinfection of currently produced casings is less efficient and much more chemicals are needed.

Casing produced in accordance with the new method not only solves many problems related to casing production and use in mushroom cultivation, but also opens up numerous additional opportunities for mushroom growers around the world (side effect). Much broader range of raw materials (including those that previously could not be used for abovementioned reasons) can be used with this method for production. In general, application of the new method enables production of casing from locally available materials for filling of agglomerates. Moistening, formation of water store, acidity correction, adjustment of size, rigidity, shape, etc. are all possible.

The new method for production of casing would substantially lower costs of casing production, reduce transportation, and decrease environmental pollution. The new, much more efficient method for pasteurisation of casing opens up additional possibilities to reuse mixture of mushroom substrate and casing used in production process. With currently available mushroom cultivation technologies reuse of substrate in casing production process is limited by the following factors: used (spent) substrate contains fungal pathogens as well as organic salts that need to be removed by washing substrate with water (usually substrate is spread on the ground outdoors and rainwater washes salts to the ground), washed and composted substrate does not have any structure, which makes mushroom cultivation on such casing not optimal. With the new method for production of casing the spent and composted substrate can be used as raw material to serve as filling when making structure of crumbles/balls. Additional materials are blended in the material to ensure appropriate absorption, stickiness, and acidity of material. Then fibres are blended in and agglomerates/balls of required size are formed by the previously described new method for production. Influence of organic acids on growth of spawn is smaller, because spawn usually grows at the surface where it interacts more with fibre materials than with spent substrate located inside agglomerate. Thus time-consuming and environmentally problematic process of removal of salts from spent substrate is simplified. Casing containing raw materials of spent mushroom substrate must be subjected to proper thermal processing (disinfection), because raw materials in spent substrate often contain pathogens, and the disinfection is ensured by one of the stages of the new method for production of casing, which has been described above and employs airflow heat guided from compost pasteurisation room, which makes it more cost-efficient and accessible.

This new method for production makes it possible to

substantially reduce transportation costs;

form casing with required structure and relatively lower moisture content (compared to presently widely used ‘heavy’ casing);

build better structure with desired crumble size and fraction.

If transportation distances are long and delivery costs are high, casing produced in accordance with this invention can be dried by using excessive heat generated during different stages of mushroom growing. Casing with lower moisture content is not only easier to transport, but also less likely to get infected with competing microorganisms, which is particularly important when transportation distances are long. The said drying has minor effect on crumble structure. Meanwhile drying presently used ‘heavy’ casing changes its physical properties dramatically.

Method for production of casing according to this invention is more focused on dealing with problems related to cultivation of mushrooms, but the method can also be successfully used for other applications (e.g., plant growing, horticulture, gardening, floriculture) requiring dealing with problems of aeration and water absorption. Structure of mixes frequently used in plant growing, horticulture, gardening, and floriculture must have stable structure, in other words, mixes have to retain their proper structure. Mixes with stable structure are needed to ensure aeration of roots and water absorption of plants. Nowadays such mixes are sometimes carried thousands of kilometres, but application of the method for casing production in accordance with this invention would enable use of locally available materials and discontinuation of costly transportation. Moreover, mixes could often be reusable, but soil pasteurisation is technically complicated to do. By using casing (casing layer or mix) production method according to this invention the said mixes could be pasteurised easily and well (pasteurisation process is simplified and economically feasible).

This new method for production of structural mixes would enable expansion of producing capacities of peat bog operators, because this method for production of structural mix allows use of wet, natural peat that, after mixing and formation of crumbles, could be dried by using currently available active ventilated container or room drying technology, because structure of the mix allows for efficient ventilation of it. Moreover the mix can be not only ventilated, but also moistened by adding certain amount of humidity to air used for ventilating.

To illustrate and describe this invention, descriptions of preferred embodiments are given above. This is not a complete or limiting invention aimed at prescribing a precise embodiment or implementation option. The description given above should be regarded more as an illustration than a constraint. Obviously, the specialists in this field may clearly see a multitude of modifications and variations. The preferred embodiments have been selected and described so as to enable the specialists in this field to best understand the principles behind this invention and their best practical application for different embodiments with different modifications fit for a specific application or implementation customisation, because with specific variety of mushrooms there may be different quantitative indicators relating to application of this method. The invention scope is defined by the attached definition and its equivalents wherein all the terms used have the broadest possible meaning unless stated otherwise. It must be admitted that implementation options described by specialists in the field may contain changes that do not depart from the scope of this invention, as described in the definition given next.

### Mode for the Invention

### Mode for Invention

### INDUSTRIAL APPLICABILITY

### Sequence Listing Free Text

### Sequence List Text

1-8. (canceled)

9. A production method of casing for cultivation of mushrooms and/or plants comprising:
preparation and mechanical processing of primary raw materials of organic and mineral origin,
wherein the method comprises the following stages:
smoothing, moistening, and mixing of paste of the said primary raw materials by mechanical action, i.e., by shaking, rotating, and rolling; preparation of fibre of organic and/or mineral origin (e.g., peat fibre); gradual blending of the said raw materials with the said fibre by mechanical action, i.e., by shaking, rotating, and rolling, in the course of which the said fibre turns the said raw materials into crumbling components and performs the function of binding/grouping (primary conglutination);
further blending of the said formed crumbles by continued mechanical action (shaking, rotating, and rolling) with the rest of the said fibre, during which bound/grouped crumbles agglomerate even more and resemble agglomerates (secondary conglutination);
separation of too small fraction of the said formed agglomerates and guiding to the start of process;
separation of desirable fraction of the said formed agglomerates and guiding them to casing production/building section where agglomerates of desirable size are used to make casing characterised by desirable structure and mechanical strength;
separation of too large fraction of the said formed agglomerates and guiding to shredder section from which shredded agglomerates are guided to the start of process.

10. The method for production of casing according to claim 9, wherein the method additionally comprises:
placing of the said agglomerates (casing) into closed ventilated container where pasteurisation procedure is carried out very efficiently by using hot (˜58° C.) air generated by mushrooms themselves (during growing) or other source of heat.

11. The method for production of casing according to claim 9, wherein the method additionally comprises:
drying of the said agglomerates (casing) (previously one of the greatest problems, because drying was not possible due to structure and characteristics of casing).

12. A system for production of casing according to the method of claim 9, wherein the system contains the following units:
ingredient feed unit (1) feeding paste of primary raw materials into structurer (3);
fibre feed unit (2) feeding fibre into structurer (3);
structurer (3) made up of mixer wherein smoothing, moistening, and mixing of the primary raw ingredients take place, and agglutination section wherein the mixed raw paste is gradually mixed with the said fibre to first form crumbles and later agglomerates;
sorting unit/separator (4) wherein processes of sorting of the said agglomerates by size take place;
too small fraction separation unit (5) wherein agglomerates that are too small are separated and guided to the start of the process, i.e., to structurer (3);
desirable fraction separation unit (6) wherein agglomerates of desirable fraction are separated and guided to section where casing featuring desirable structure and mechanical strength is produced;
shredding unit (7) accepting agglomerates that are too large and returning them to the start of the process, i.e., to structurer (3); and conveyor system (8) returning agglomerates of different fractions to different sections (to beginning of the process or casing production section);
where structurer (3) and separator (4) make a single, cylinder-shaped housing and are permanently connected to each other.

13. A system for production of casing according to the method of claim 9, wherein the system contains the following units:
ingredient feed unit (1) feeding paste of primary raw materials into structurer (3);
fibre feed unit (2) feeding fibre into structurer (3);
structurer (3) made up of mixer wherein smoothing, moistening, and mixing of the primary raw ingredients take place, and agglutination section wherein the mixed raw paste is gradually mixed with the said fibre to first form crumbles and later agglomerates;
sorting unit/separator (4a, 4b) wherein processes of separation of the said agglomerates that are too small and guiding to the start of the process (i.e., to structurer (3)) take place;
sorting unit/separator (5a, 5b) wherein processes of separation of the said agglomerates that are of desirable fraction and guiding to the section of production of casing featuring desirable structure and mechanical strength, take place;
shredding unit (7) accepting agglomerates that are too large and returning them to the start of the process, i.e., to structurer (3); and conveyor system (8) returning agglomerates of different fractions to different sections (to beginning of the process or casing production section);
where:
structurer (3) and separator (4a, 4b and 5a, 5b) are separated from each other; and the said separators (4a, 4b and 5a, 5b) are based on rotating paddles distance between which can be changed and size of agglomerates can be easily customised.

14. A method for use of casing according to the method of claim 9, wherein an uneven surface of casing on uneven substrate layer is obtained,
where the said unevenness of substrate layer can be produced by various techniques, e.g., by mechanically pressing (through casing) the even substrate layer located right under the casing.

15. The method for use of casing according to claim 14, wherein the surface of casing is wavy or features some other regular or irregular pattern.

16. The method for use of casing according to claim 14, wherein the extra casing (best when made of paper) with apertures allowing passage of air from outside to spawn in casing only at points chosen by grower (resulting in pinning in predefined order) is placed in predefined manner on surface of casing for cultivation.
